(19) United States
(12) Patent Application Publication
(10) Pub. No.: US 2011/0306272 A1
(43) Pub. Date: Dec. 15, 2011

(54) BOTTOM BOARD FOR A BEEHIVE

(76) Inventor: Stuart Lyon Ferguson, Featherston (NZ)

(21) Appl. No.: 13/159,416

(22) Filed: Jun. 14, 2011

(30) Foreign Application Priority Data
Jun. 14, 2010 (NZ) 586140

(51) Int. Cl. A01K 47/06

(52) U.S. Cl. 449/25

(57) ABSTRACT

A beehive bottom board is disclosed that includes recessed areas at the front of the bottom board defining openings for the hive entrance. The size of the hive entrance may be adjusted by sliding a mounted hive body forwards or backwards.

### FIELD OF THE INVENTION

The present invention relates to a beehive bottom board. More particularly but not exclusively the present invention relates to a bottom board for a beehive that has an adjustable hive entrance.

### BACKGROUND TO THE INVENTION

A modern beehive for cultivating bees is generally in the form of a box with components that can be removed for inspecting the hive or accessing the honey. The box provides most of the structure of the hive and the bees form the internal hive components to maintain the bee colony. The most popular forms of modern hives will include a bottom board as the base on which the hive body rests. An opening between the bottom board and one of the walls of the hive body provides the entrance to the hive for the bees to enter and exit.

A typical prior art bottom board is shown in U.S. Pat. No. 4,682,380 comprising a flat board as a base, and upstanding walls on three sides of the base. A gap is provided for bees to enter and exit the hive. The size of the gap is usually restricted to prevent entry to the hive of unwanted intruders, such as larger insects, mice and other rodents.

An issue of increasing concern to bee keepers is infestation of a hive by pests, such as the Varroa mite (Varroa destructor). A Varroa mite is an external parasite that clings to the body of a bee and feed from the bee by sucking hemolymph from the bee's body. This can result in significant weakening of the bee and the spread of diseases such as viruses. The mites can reproduce quickly and can rapidly spread amongst the bee population in a hive. A Varroa mite infestation can be very detrimental to the health of a hive colony and can lead to death of the colony.

The Varroa mites, as external parasites, are prone to falling off the bees, either accidentally or from grooming by the bees. There have been various attempts in the prior art to exploit the falling of the mites as a way of measuring or reducing an infestation. The hive of U.S. Pat. No. 4,867,731 uses a sticky trapping surface under a fine mesh screen, placed on the bottom board of the hive. Mites that fall from the bees while over the mesh screen, fall through the screen and are trapped on the sticky trapping surface. The mites, which are about 1.5 mm long and 2 mm wide can fall through the mesh, while the much larger bees are kept away from the trapping surface.

The patent document FR 2705528 describes a hive construction that comprises a bottom tray comprising bars, which is placed under the hive frames. The bars are tube shaped and spaced apart to allow the Varroa mite to fall through. The bars are fixed into the inner walls of the frame.

The patent document U.S. Pat. No. 7,390,238 uses a similar construction, wherein the base comprises multiple circular bars, arranged with a small gap between each bar. The bars are held in place by lateral cross-pieces, rather than by attachment or insertion into the surrounding wooden frame. The lateral cross-pieces are attached to the wooden frame, holding the bars in place.

Another pest that is of concern to beekeepers is the small hive beetle, which can cause damage to the comb, stored honey and pollen, and brood. A heavy infestation can result in abandonment of the hive by the bee colony. The adult beetles lay eggs in the hive, and the hatched larvae feed on the honey and bee brood. The larvae leave the hive after around 10 to 14 days to pupate in the soil near the hive. After pupation the mature beetles re-enter the hive. Bottom boards with meshes or bars used in conjunction with a trap below the bottom board can be used to trap and kill the small hive beetle and their larvae particularly as they enter or leave the hive. Typically, oil or diatomaceous earth is used in the trap below the bottom board to kill the beetles and larvae.

There are various problems with the devices of U.S. Pat. No. 4,867,731, FR 2705528 and U.S. Pat. No. 7,390,238. The use of open mesh can leave the hive too exposed to cold air and can become blocked with beehive debris between hive visits by a beekeeper, thus reducing potential clearance passage for mites. The use of hollow tubes within the hive may lead to infestation of diseases and/or pests within the tubes, which would be difficult to discover without dismantling the bottom board. The use of multiple components, such as wooden sides, plastic tubes, fasteners and tube supports combined with paraffin wax dipping and paint to preserve woodwork, in the construction of the bottom board makes it unnecessarily expensive and time consuming to manufacture and maintain. The crevices in the wood frame of the cross-braces can harbour debris, disease-vectors and insects. The shape of the bars is limited to a round bars, which does not necessarily provide the most effective means of removing fallen mites, or other insects.

The entrance to a beehive in the prior art is generally provided by the gap between the bottom of the front wall of the hive body and the base of the bottom board. During summer or other high productivity times it is desirable to have a relatively large hive entrance to allow large number of bees to enter and exit the hive. During colder periods, it may be undesirable to have a large hive entrance, as the entrance is not usually necessary and can lead to cold air entering the hive. It is common practice for a beekeeper to partially block the hive entrance during winter to trap warmth in the hive. A number of crude methods are often utilised, such as stuffing a cloth into the entrance. Methods such as this may not be consistent and effective enough to properly provide the right environment for the hive.

Accordingly there is a need in the art for an improved bottom board for a beehive that improves on at least some of the shortcomings of the prior art.

### OBJECT OF THE INVENTION

It is an object of the invention to provide a bottom board for a beehive that provides an adjustable hive entrance, and/or to at least provide the public with a useful choice.

### SUMMARY OF THE INVENTION

As used herein the terms bee and bees generally refer to domesticated and/or cultivated honey bees.

In one aspect the invention broadly consists in a bottom board for a beehive, comprising:
a support structure, wherein the top surface of said support structure is suitable for receiving a hive body, wherein:
said support structure includes a recessed portion that is capable of providing a hive entrance when combined with a hive body; and
wherein the size of said hive entrance may be altered by adjusting the relative position of said hive body.

Preferably said recessed portion includes a first recess and a second recess.

Preferably, when combined with a hive body, a fully open hive entrance is provided when said hive body position utilises at least the first recess for the hive entrance, and a reduced hive entrance when said hive body position utilises only the second recess for the hive entrance.

Preferably, said hive body may be positioned so that the hive entrance is blocked.

Preferably the top surface of the support structure includes protrusions that are capable of limiting the movement of a mounted hive body when in use.

Preferably movement of said hive body when in use is substantially limited to sliding movement in one axis.

Preferably the bottom board includes within the area defined by said support structure, a plurality of spaced apart substantially parallel bars.

Preferably the space between said bars is between 2.5 and 4 mm.

Preferably the bottom board is a unitary moulded, one-piece construction.

Preferably the cross-section of said bars is substantially parabolic.

Preferably the bottom board includes at least one removable identification marker, wherein said at least one marker is capable of identifying a hive to a bee.

Preferably the at least one identification marker is positioned near said region on said support structure capable of providing an entrance when in use.

Preferably the at least one identification marker is of a colour and/or shape recognisable to a bee.

Preferably the bottom board comprises at least two identification markers.

Preferably the bottom board is nestable.

In another aspect the invention broadly consists in a bee hive including the aforementioned bottom board.

### BRIEF DESCRIPTION OF THE FIGURES

Preferred forms of the invention will now be described with reference to the accompanying figures in which:

FIG. 1 shows a top view of a beehive bottom board of the invention;

FIG. 2 shows a front elevation view of a beehive bottom board of the invention;

FIG. 3 shows a side elevation view of a beehive bottom board of the invention;

FIG. 4 shows an isometric view of a bottom board of the invention;

FIG. 5 shows the fully open ‘Summer Position’ position of a hive body on a bottom board of the invention;

FIG. 6 shows the partially open position ‘Winter Position’ of a hive body on a bottom board of the invention;

FIG. 7 shows the fully closed position of a hive body on a bottom board of the invention;

FIG. 8 shows an isometric view of a bottom board of the invention, including identification markers.

FIG. 9 shows an isometric view of the bottom board of the invention with an attached stop clip in a disengaged position;

FIG. 10 shows an isometric view of the bottom board of the invention with an attached stop clip in an engaged position;

FIG. 11 shows a cross-section of a bottom board of the invention with stop clip in engaged position;

FIG. 12 shows details of a cross-section of a bottom board of the invention and stop clip in engaged position;

FIG. 13 shows a front elevation view of a stop clip for a bottom board of the invention;

FIG. 14 shows a side elevation view of a stop clip for a bottom board of the invention;

FIG. 15 shows an isometric view of a bottom board of the invention including a hive lock;

FIG. 16 shows an isometric view of a hive lock;

FIG. 17 shows an isometric view of a bottom board of the invention with attached trays;

FIG. 18 shows an isometric view of a bottom board of the invention with attached trays and an unattached tray;

FIG. 19 shows a tray for a bottom board of the invention;

FIG. 20 shows an isometric view of the underside of a bottom board of the invention with attached trays and an unattached tray;

FIG. 21 shows a top view of a bottom board of the invention configured for an eight-frame hive body;

FIG. 22 shows an isometric view of a bottom board of the invention configured for an eight-frame hive body;

FIG. 23 shows a cross-sectional view of a bottom board of the invention with an eight-frame hive body and trays.

### DETAILED DESCRIPTION OF THE PREFERRED EMBODIMENTS

In reference to the figures, the preferred embodiments of the invention will be illustrated by way of non-limiting example.

Although it is anticipated that the general invention as described has other uses, the preferred use of the invention is as a base board for a beehive.

The bottom board of the invention generally includes recessed portions at the front for providing an alterable hive entrance. The largest hive entrance is generally referred to as the ‘summer position’ and a reduced hive entrance is generally referred to as a ‘winter entrance’, although the actual time of year or uses of the bottom board or particular hive entrance are in no way restricted to the seasons. Any reference to the relative size or accessibility of the hive entrance is generally in relation to the bees that occupy the hive. For instance, an open hive entrance provides an opening of sufficient size for the bees of the hive, but preferably is too small for larger predators, pests, or other undesirable intruders.

### Example 1

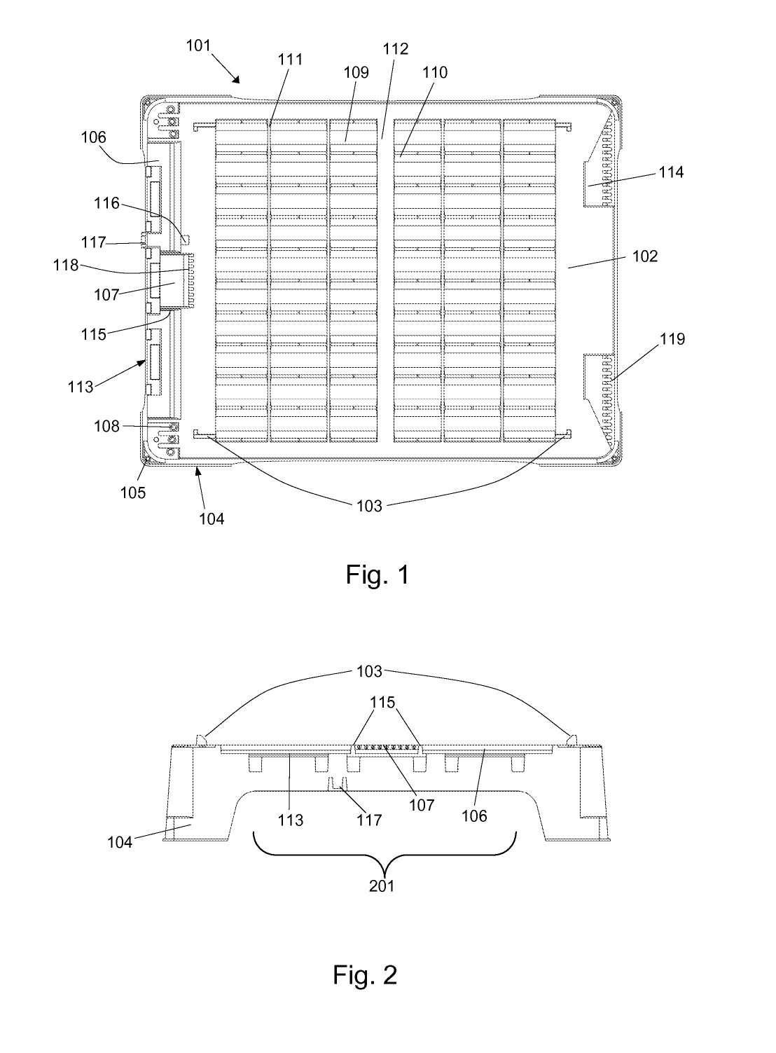

FIG. 1 shows a top down view of a preferred embodiment of the beehive bottom board of the present invention. The bottom board 101 is a single moulded component, including various features integrally moulded into the structure.

Preferably the bottom board is moulded from a suitable polymer material. A preferred polymer material is food grade High Density Polyethylene (HDPE). It is preferred that the polymer has very low levels of Volatile Organic Compounds (VOCs).

The bottom board is a generally rectangular configuration, comprising a top surface 102 on which a hive body (not shown in FIG. 1) can be placed. Protrusions or lugs 103 integrally moulded on the upper surface are used as means for retaining a hive body in place. The size of the bottom board and spacing of the lugs 103 is intended for a ten-frame hive body in this embodiment. The four corners of the bottom board include integrally moulded feet 104 that elevate the bottom board above the surface on which it rests.

The feet include mounting holes 105 that can be used to attach the bottom board to a surface, such as a wooden pallet. A variety of fastening devices can be used to attach the bottom board, such as nails, screws, or staples.

On the front side of the bottom board, a first recess 106 provides an entrance gap for bees when the bottom board is in use with a hive body. The bottom of the proximal wall of the hive body when situated over the first recess provides a space for the bees to enter and exit the hive. When in this position, ahive body is said to be in the ‘summer position’. The depth of the recess is preferably limited to provide a suitable space for bees to enter and exit, but too small for larger insects, rats, mice and other rodents to enter the hive.

Another narrower, second recess 107 is preferably included, that provides a smaller hive entry when the proximal wall of a hive body is situated over the second recess. The hive body when positioned to only allow access to the hive through the second recess is said to be in the ‘winter position’. The second recess extends further back towards the centre of the bottom board (towards the inside of the hive when in use), and at the same depth as the first recess. Further partition walls 115 where the first and second recesses coincide may be included, to more fully control the size of the reduced entrance when in use.

Means for fixing the position of the hive body on the bottom board can also be included. For example fastening pins (not shown) can be inserted into suitably positioned pin holes 108 to prevent movement of the hive body.

Within the central area of the bottom board are a plurality of parallel bars 109 that provide a partially open floor for the hive. The bars are spaced so that there is a gap 110 between the bars, which can provide for ventilation and clearance of pests, such as Varroa mite. Preferably the gap between adjacent bars is large enough for pests to fall through, but too large for bees to pass through. Typically the gap between adjacent bars at the widest point of the bars will be between 1 mm and 4 mm.

If the gap between the bars is too large, the bees of the hive may use the underside of the bottom board as an entrance to the hive. This is undesirable as it doesn't give suitable control of the bees behaviour and is makes protection and management of the more hive more difficult for the bees. A too small a gap and it may not be sufficient for mites and other pests to fall through. A smaller gap also provides less ventilation for the hive. Accordingly the size of the gap between the bars depends on various factors and may be selected depending on the circumstances of the hive, the size of potential pests and the desired effects on the hive.

The bars are preferably shaped in a way that promotes the fall of pests through the gaps between the bars. Preferably the bars are shaped so as to provide a generally sloping surface that promotes clearance of pests through the gaps between the bars. A preferred shape of bar comprises an apex on the top surface of the bar, and with sides that slope outwards and towards the widest point of the bar at the base of the bar.

The shape of bar of the preferred embodiment is a substantially parabolic shape, comprising an apex on the top surface and sides that curve outwards with an angle of curvature that continuously increases to the steepest point at the base of the bar. The curved side of the bars are intended to inhibit a parasite's ability to move from the bottom board back into the hive by crawling across the bars. Preferably the polymer used to mould the bottom board is of a type that offers low adhesion to pests.

In the preferred embodiment the bars are essentially hollow, such that the underside are uncapped, which saves weight, material cost, and is more convenient to manufacture. In alternative embodiments the bars may be solid, capped on the underside, or other shapes and configurations depending on the need for strength, function or other parameters, such as a desire to limit crevices that may provide living spaces for pests.

To improve strength and rigidity, the preferred bottom board includes cross-braces 111, and a centre-brace 112 substantially perpendicular to the bars. In alternative embodiments the centre-brace and cross-braces are not present.

The bottom board preferably includes attachment points 113 for securing further components. Such components may include identification tags (not shown in FIG. 1) for the hive, which can be recognised by the bees. Some beekeepers mark the entrance of the hive with different coloured paint, to make it easier for bees to recognise their own hive, particularly when there are multiple hives close together. Another additional component that may be secured to the attachment points is a pollen trap.

Indents 114 can be provided on the top surface of the bottom board as leverage points for a hive tool. In the preferred embodiment, indents are provided at the back of the bottom board, where a hive tool or other suitable tool may be inserted for moving and/or adjusting the hive body.

An opening 116 is provided for the inclusion of a stop means (not shown) for preventing a mounted hive body from sliding back into a position that blocks all entry into the hive. A further guide portion 117 is provided for an attached stop means that would utilise the opening 116.

Hive bodies that have worn edges at the base, or use a non-standard size or thickness of material, may provide a gap that is large enough for bees to escape when the hive body is in the closed position. To help prevent this, a plurality of projections 118 are included at the end of the second recess and extend slightly into the recess to prevent bees from escaping when in the closed position, but allow more air-flow when in the winter position compared to just a shorter recess.

Similar projections 119 are located on the indents to extend the surface of the indent to prevent bees from escaping from the back of the hive when in the closed position.

FIG. 2 shows a front elevation view of the bottom board. The integral feet 104 elevate the bars of the bottom board above the surface on which it rests, providing clearance for debris fall, including pests. The clearance of the preferred embodiment is 62 mm from the bottom of the bars to the resting surface. The open space 201 in between the feet is useful for establishing air-flow and ventilation beneath the bottom board and within the hive.

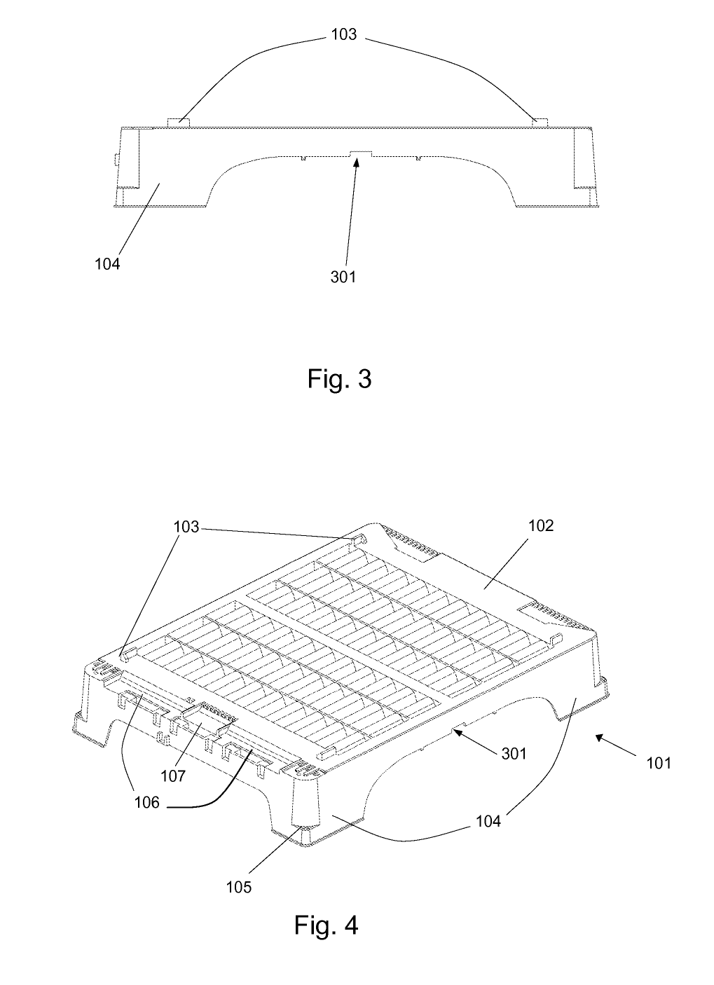

FIG. 3 shows a side elevation view of the bottom board. A recess 301 can be provided in the side walls of the bottom board as a guide and/or locator for a strap that can be bound around the hive, to secure the hive body and the bottom board together.

FIG. 4 shows an isometric view of a preferred embodiment of the bottom board.

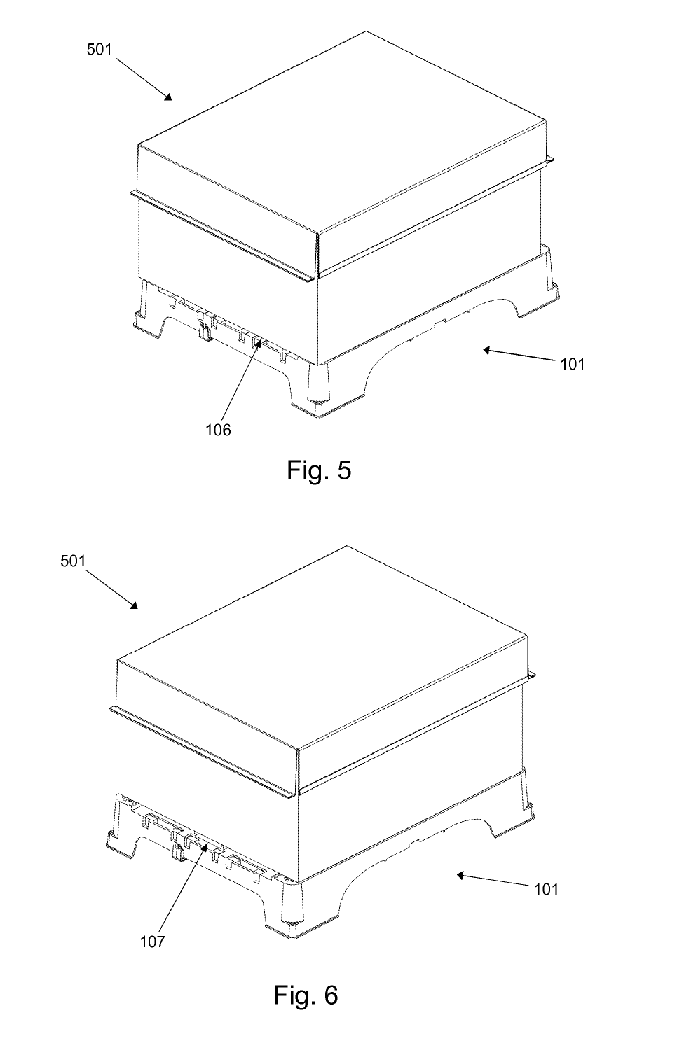

FIGS. 5-7 show an isometric view of how a hive body would be placed on the bottom board. The arrangement of the first and second recesses allows for adjustment of the hive entrance by changing the relative position of the hive body 501. The hive body can be slid or otherwise moved along the top surface of the bottom board 101 to alter the entrance opening. As shown in FIG. 5, when the hive is placed in the summer position, the first recess 106 is available as an entrance as well as the second recess. The hive entrance is at its largest, and provides full access for when it is required by the bees during busy harvesting periods, such as during spring and summer.

As shown in FIG. 6, the hive body can be slid back towards the centre of the hive into the winter position, so that only the second recess 107 provides an entrance to the hive. This configuration reduces the heat loss through the opening compared to the fully open entrance, and is more suitable for when less access is required by the bees, such as during winter. The smaller opening is also better able to be protected by guard bees, particularly at times of low activity such as winter.

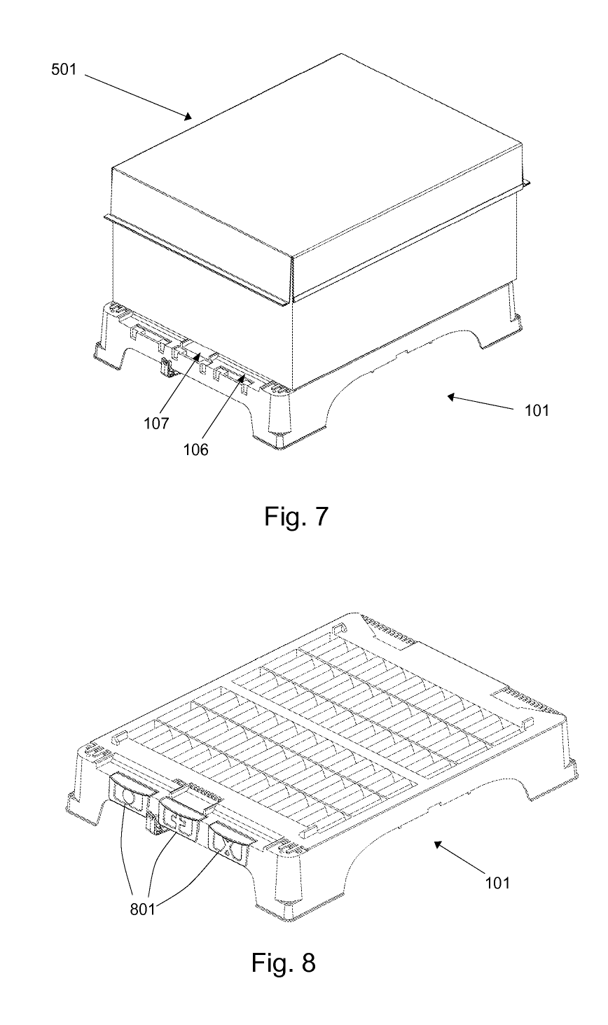

As shown in FIG. 7, the hive body can be slid back even further so that entry to the hive from both the first recess 106 and second recess 107 is blocked. This fully closed position can be used for trapping the bees inside the beehive, such as may be desired when transporting the hive and colony. The lugs 103 on the top surface of the bottom board (as shown in FIG. 1) can act as guides for the hive body, keeping it in place when the hive body is slid along the surface. The lugs can also act as stops, preventing the hive body from sliding to far either backwards or forwards. The lugs can be arranged so the when the hive body is slid fully back until the inside wall of the hive body contacts the lug, the fully closed position has been reached.

As shown in FIG. 8, the preferred embodiment of the beehive bottom board of the present invention uses removable tags 801 comprising different colours and/or shapes that can be identified by bees. It is preferred that the colours of the tags are in within the colour spectrum that can be readily seen and differentiated by bees. It is easier for the beekeeper if the colours are also within the spectrum that can be seen and differentiated by humans. Different hives can be labelled with different tags or combinations of tags to better enable the bees to recognise and return to the same hive. Controlling this behaviour can be useful in preventing or reducing cross-contamination of transferable diseases between hives.

In the preferred embodiment, three tags may be attached at the front of the bottom board, where the hive entrance is located. The colour and shape combination of these tags are selected to differentiate the hive from other nearby hive. The tags are secured to the attachment points on the bottom board. The tags are removable, such as for cleaning, reuse, changing the tag combination, or to secure a different component to the bottom board.

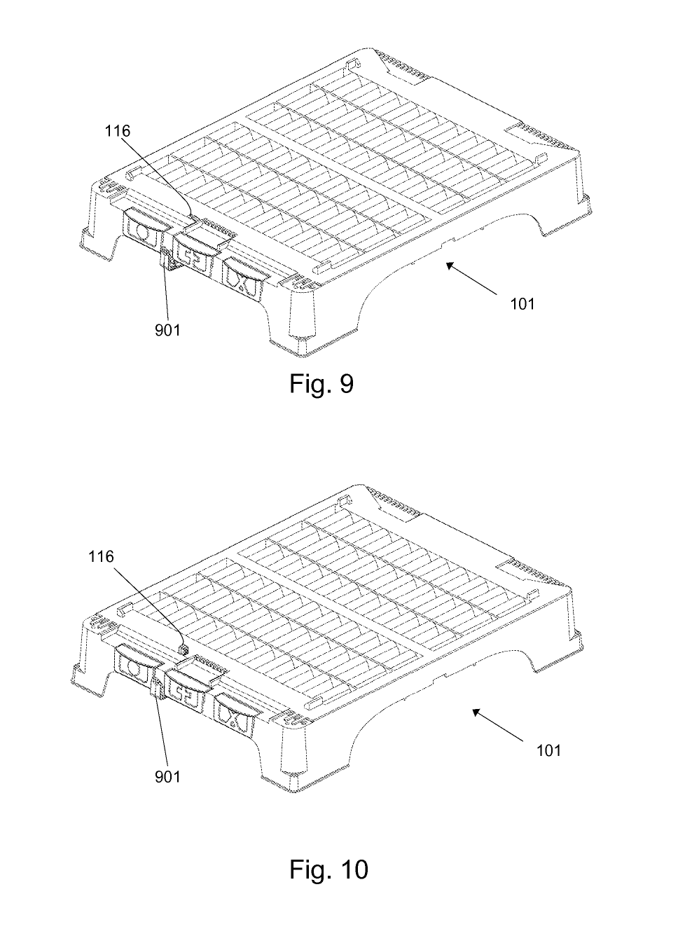

Shown in FIG. 9 is an isometric view of the embodiment, with an attached stop clip 901. The clip is in the disengaged position, wherein the stop portion has been slid below or flush with the opening 116. An attached hive body (not shown) could be slid back into the fully closed position, in which the hive entrance is blocked to entry or exit by bees.

Shown in FIG. 10 is an isometric view of the embodiment wherein the stop clip 901 is in the engaged position and protrudes from the opening 116. An attached hive body (not shown) would be impeded by the stop clip 901 and would not be able to be slid back further than the partially closed, winter position, as shown in FIG. 6. The stop clip thereby prevents accidental, complete closure of the hive entrance, such as by stock contacting the hive body, which could potentially slide the hive body into a closed position.

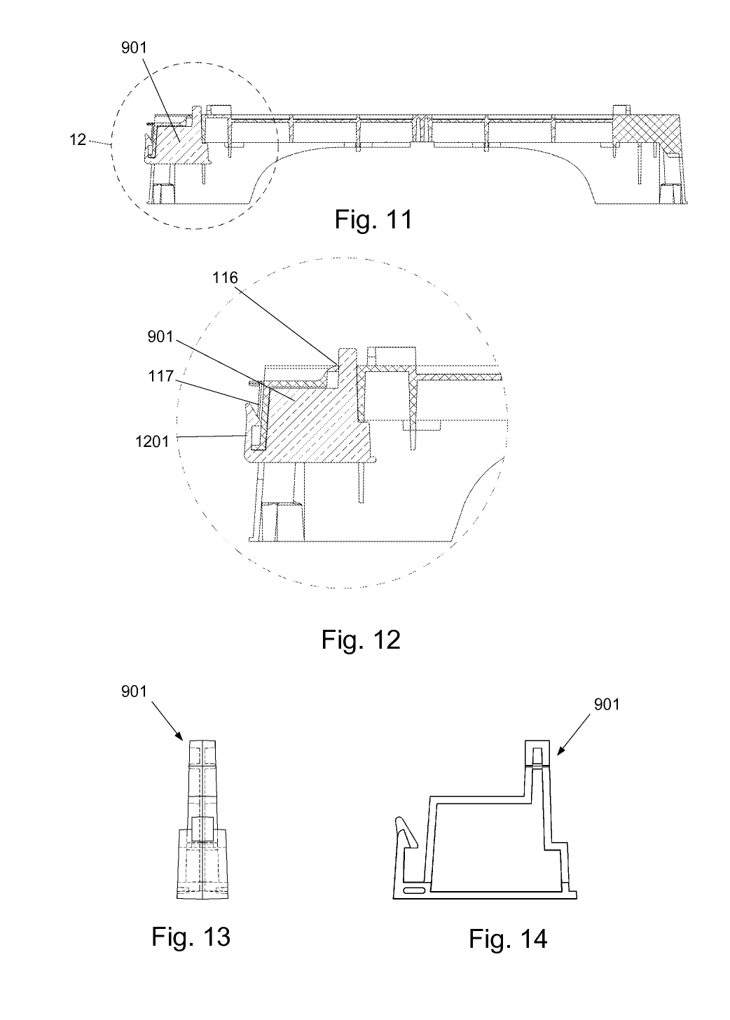

FIG. 11 shows a cross-section of the preferred bottom board where the positioning of the stop clip 901 can be seen. The detail view of FIG. 12 shows a cross-section through the stop clip 901 and the position of a guide leg 1201 that holds the clip in position on the guide portion 117 and directs the movement of the clip from the disengaged position as shown, to an engaged position. In the engaged position, the stop clip protrudes from the opening 116 to obstruct movement of a hive body (not shown in FIG. 12). A front elevation view of the stop clip 901 is shown in FIG. 13. A left side elevation view of the stop clip 901 is shown in FIG. 14.

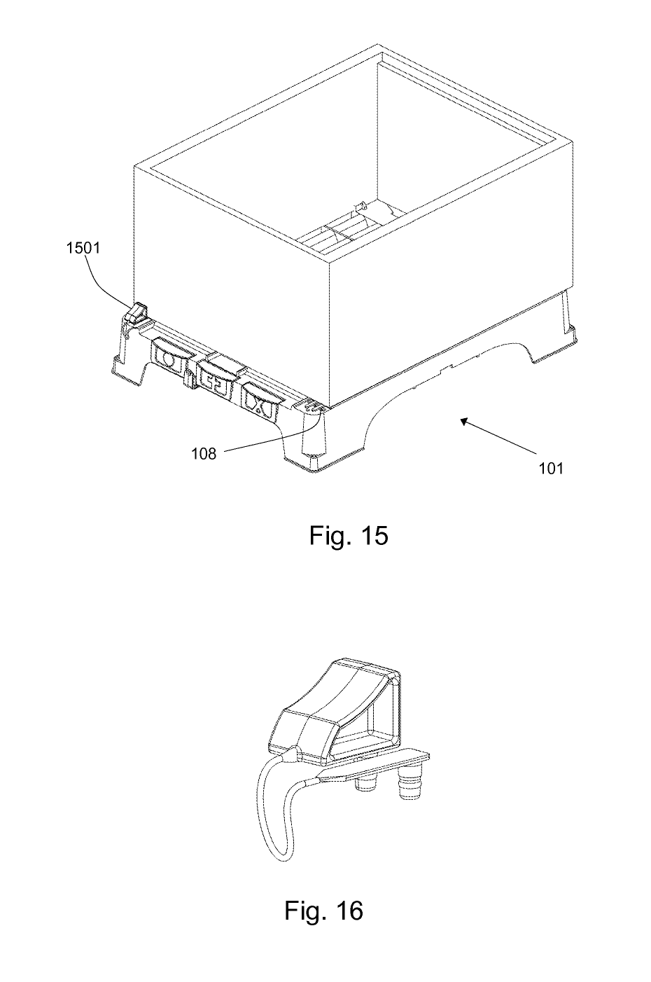

FIG. 15 shows an isometric view of a bottom board with a hive lock component 1501 in place. The hive lock is used to prevent the hive body from being moved into the summer position, such as by livestock or by the wind. The hive lock fastens to the bottom board using the mounting holes 108. The hive lock component is how by itself in FIG. 16.

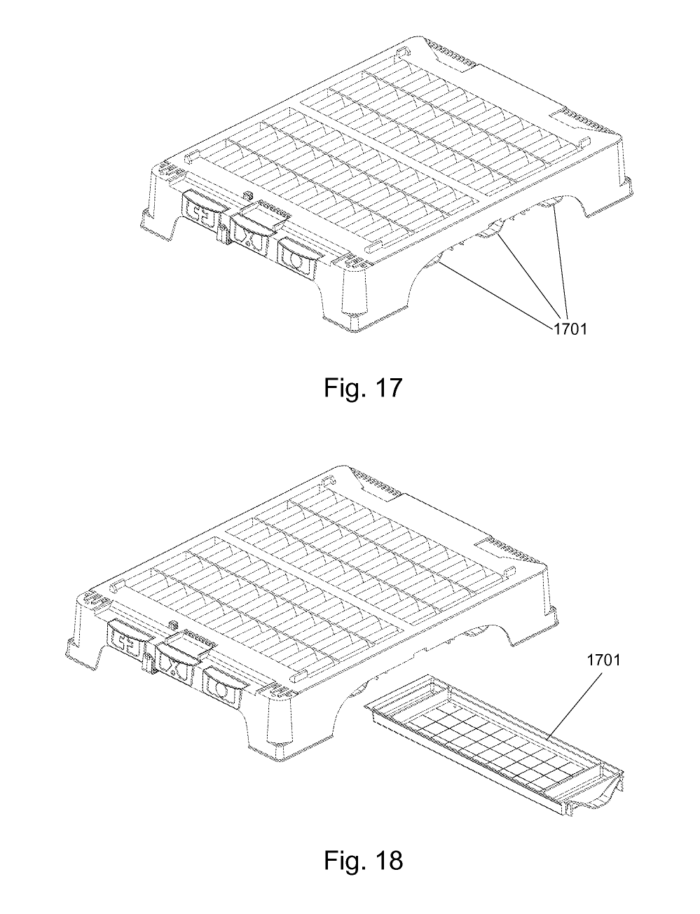

FIG. 17 shows an isometric view of a bottom board with three trays 1701 attached to the underside. These trays can be used to collect any pests, such as Varroa mite and small hive beetle that fall through the bottom board bars. FIG. 18 shows a bottom board and a tray 1701 separately. The trays may also contain a trapping substance, such as food grade silicone oil, that adheres to and kills the fallen pests. Trapping the pests in oil can be useful for preventing the parasite from re-entering the hive, and as a measure to the beekeeper of the infestation level of the hive. Diatomaceous earth may also be a suitable substance for trapping and killing pests, such as small hive beetle.

FIG. 18 shows an isometric view of a bottom board with a tray 1701 removed.

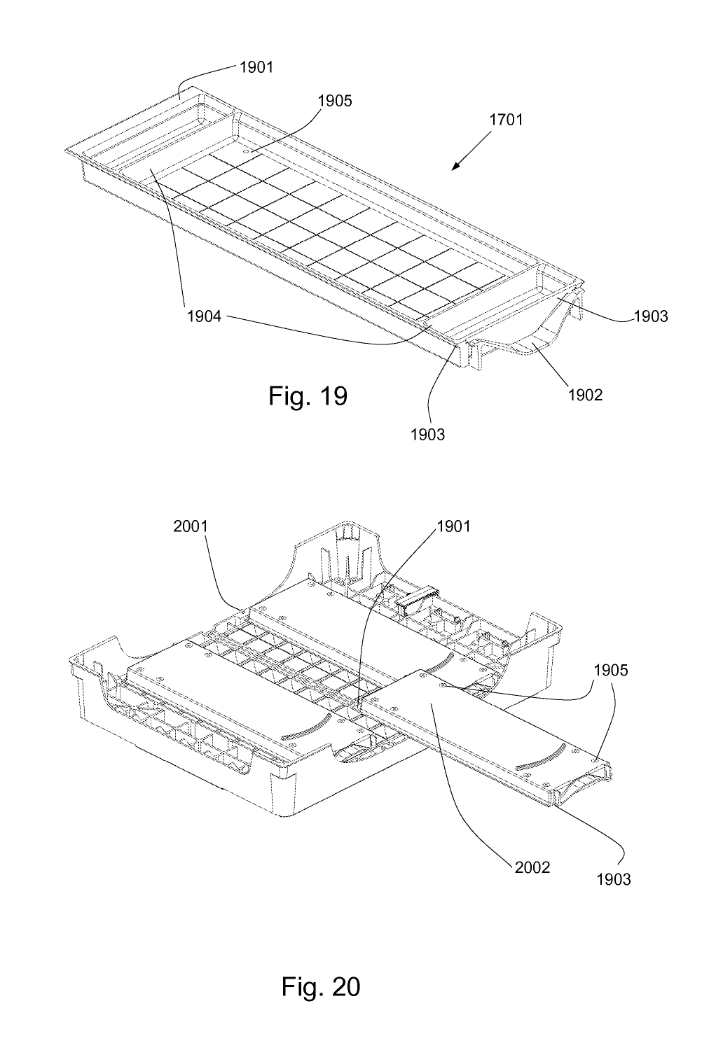

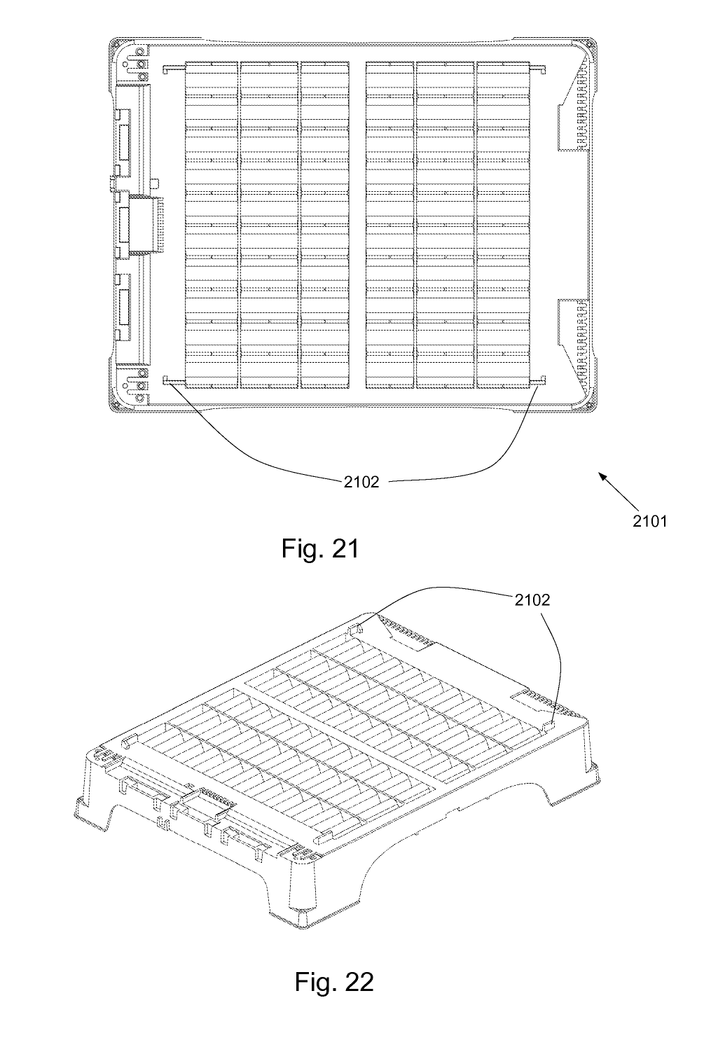

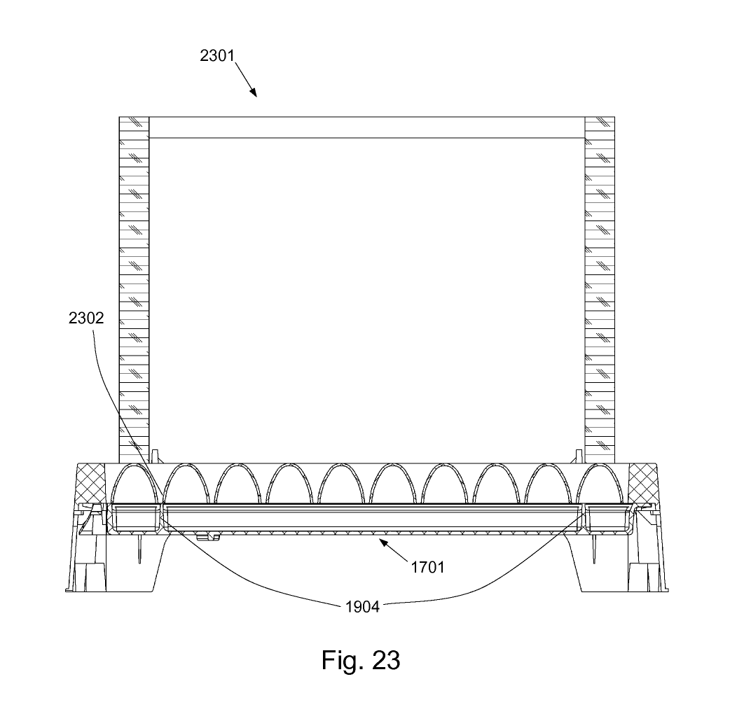

FIG. 19 shows an isometric view of a tray 1701 suitable for use with the bottom board of the invention. The tray includes a projecting lip 1901 at one end of the tray and a curved handle 1902 at the other end. Projecting laterally from each side of the curved handle are tabs 1903 that are used for fastening the tray to the bottom board. Inner dividing walls 1904 are included in the interior of the tray, as a means for inhibiting the ability of pests to escape from the ends of the tray when a smaller hive body is mounted to the bottom board. Drainage holes 1905 are located on the base of the tray for allowing water to drain out.

The use of HDPE or other suitable polymers allows the bottom boards of the present invention to be sterilised if necessary. For example, if a hive is infected with American Foul Brood (AFB), the bottom board can be cleaned and sterilised, such as with bleach solution, while wooden boards would need to be destroyed.

The inclusion of interspaced bars for clearance of pests, integrally moulded into the bottom board, provides a means for reducing infestation of pests, clearance of debris and better ventilation of the hive. The moulding manufacturing process also allows for different designs and shapes of bars to attain a more effective product.

The moulded bottom boards of the present invention are also significantly lighter at approximately 1.5 kg each, than wooden bottom boards which are approximately 6 kg each. This can reduce the overall weight of the hive by 30%. The bottom boards of the present invention are also nestable, which provides greater convenience in storage and transportation, as a multitude of boards takes up less space then the same number of traditional wooden boards.

1. A bottom board for a beehive, comprising:
a support structure, wherein the top surface of said support structure is suitable for receiving a hive body, wherein:
said support structure includes a recessed portion that is capable of providing a hive entrance when combined with a hive body; and
wherein the size of said hive entrance may be altered by adjusting the relative position of said hive body.

2. The bottom board as claimed in claim 1, wherein said recessed portion includes a first recess and a second recess.

3. The bottom board as claimed in claim 2, wherein when combined with a hive body, a fully open hive entrance is provided when said hive body position utilises at least the first recess for the hive entrance, and a reduced hive entrance when said hive body position utilises only the second recess for the hive entrance.

4. The bottom board as claimed in claim 3, wherein said hive body may be positioned so that the hive entrance is blocked.

5. The bottom board as claimed in claim 4, wherein the top surface of the support structure includes protrusions that are capable of limiting the movement of a mounted hive body when in use.

6. The bottom board as claimed in claim 5, wherein said movement of said hive body when in use is substantially limited to sliding movement in one axis.

7. The bottom board as claimed in claim 1, wherein within the area defined by said support structure, are a plurality of spaced apart substantially parallel bars.

8. The bottom board as claimed in claim 7, wherein the space between said bars is between 2.5 and 4 mm.

9. The bottom board as claimed in claim 7 wherein the bottom board is a unitary moulded, one-piece construction.

10. The bottom board as claimed in claim 7, wherein the cross-section of said bars is substantially parabolic.

11. The bottom board as claimed in claim 1, including at least one removable identification marker, wherein said at least one marker is capable of identifying a hive to a bee.

12. The bottom board as claimed in claim 10, wherein said at least one identification marker is positioned near said region on said support structure capable of providing an entrance when in use.

13. The bottom board as claimed in claim 11, wherein said at least one identification marker is of a colour and/or shape recognisable to a bee.

14. The bottom board as claimed in claim 12, wherein said bottom board comprises at least two identification markers.

15. The bottom board as claimed in claim 1, wherein the bottom board is nestable.

16. A bee hive including a bottom board as claimed in claim 1.
